(19) United States
(12) Patent Application Publication
(10) Pub. No.: US 2021/0284345 A1
(43) Pub. Date: Sep. 16, 2021

(54) DEICER AERODYNAMIC INTEGRATION

(71) Applicant: Ratier-Figeac SAS, Cedex Figeac (FR)

(72) Inventors: Ludovic PRUNET, Themines (FR); Arnaud ANDRZEJEWSKI, Lissac et Mouret (FR)

(21) Appl. No.: 17/201,019

(22) Filed: Mar. 15, 2021

(30) Foreign Application Priority Data
Mar. 16, 2020 (EP) 20305270.9

(51) Int. Cl. B64D 15/00

(52) U.S. Cl. CPC B64D 15/00; B64D 15/12

(57) ABSTRACT

A blade de-icing system for a blade to be de-iced that has a body extending between a leading edge and a trailing edge, said leading edge ending at an apex. The system includes a de-icer component having a recess formed therein and being positioned on said leading edge of said blade so that said de-icer component covers and extends away from said apex and so that said recess is positioned at said apex of said leading edge; and an anti-erosion strip provided in said recess of said de-icer component; wherein said anti-erosion strip and said recess are sized and shaped such that said anti-erosion strip fits within said recess so that outer surface of said anti-erosion strip is flush with the outer surface of said de-icer component. A method of manufacturing the same is also described herein.

### FOREIGN PRIORITY

This application claims priority to European Patent Application No. 20305270.9 filed Mar. 16, 2020, the entire contents of which is incorporated herein by reference.

### TECHNICAL FIELD

The present disclosure relates to improvements in de-icers for aircraft blades and methods for manufacturing aircraft blades having these de-icers.

### BACKGROUND

Electrical deicing can be used for aircraft wings or blades. Such electrical deicing can be used on the leading edge of a helicopter blade or a wind turbine blade, for example. In some systems, a deicing complex may be made integrally with the metal blade that is to be de-iced.

Improvements in such de-icing systems are, however, needed and the examples described herein relate to such improvements.

### SUMMARY

According to a first aspect, a blade de-icing system is described herein comprising a blade that is to be de-iced. The blade has a body extending between a leading edge and a trailing edge, said leading edge ending at an apex: The system further comprises a de-icer component having a recess formed therein and being positioned on said leading edge of said blade so that said de-icer component covers and extends away from said apex and so that said recess is positioned at said apex of said leading edge. An anti-erosion strip is provided in said recess of said de-icer component. The anti-erosion strip and said recess are sized and shaped such that said anti-erosion strip fits within said recess so that outer surface of said anti-erosion strip is flush with the outer surface of said de-icer component.

In any of the examples described herein, the anti-erosive strip may be adhesive or self-adhesive and may be bonded via said adhesive to and within said recess.

In any of the examples described herein, said leading edge may be tapered.

In any of the examples described herein, at its leading edge, the body of said blade may also have a recessed section for receiving the de-icing component.

In any of the examples described herein, the de-icing component may be shaped and sized so as to fit onto said recessed section of said blade body so that the outer surface of the de-icer component is flush with the outer surface of the body.

In any of the examples described herein, the anti-erosion strip may comprise a replaceable strip.

In any of the examples described herein, said de-icer component may comprises a heating element provided in a matrix. In some examples, the matrix may be epoxy resin.

In any of the examples described herein, an anti-erosion paint may be provided so as to cover at least a part of the external surface of the body of the blade.

In any of the examples described herein, the paint may be provided so as to cover the junction between the de-icer component 14 and the main body of the blade.

In any of the examples described herein, the paint may be provided so as to cover the junction between the de-icer component and anti-erosion strip.

A method of manufacturing the blade de-icing system above is also described herein comprising providing said blade having a body extending between a leading edge and a trailing edge, said leading edge ending at an apex; providing a recess in said de-icer component and positioning said de-icing component on said leading edge of said blade so that said de-icer component covers and extends away from said apex and so that said recess is positioned at said apex of said leading edge. The method further comprises providing an anti-erosion strip in said recess of said de-icer component, wherein said anti-erosion strip and said recess are sized and shaped such that said anti-erosion strip fits within said recess so that outer surface of said anti-erosion strip is flush with the outer surface of said de-icer component.

In some examples the anti-erosion strip comprises a replaceable and self-adhesive strip.

In some examples said de-icer component comprises a heating element provided in a matrix and the matrix may be epoxy resin.

In any of the examples described herein the method may further comprise providing an anti-erosion paint on said blade so that said paint covers at least a part of the external surface of the body of the blade.

In any of the examples described herein said step of providing said paint may comprise providing said paint so as to cover the junction between de-icer component and said blade body.

In any of the examples described herein, the anti-erosion strip may be a replaceable strip.

In any of the examples described herein the de-icer component may comprise a heating element provided in a matrix.

In any of the examples described herein the matrix may comprise epoxy resin.

In any of the examples described herein the anti-erosion paint may be provided so as to cover at least a part of the external surface of the body of the blade.

In any of the examples described herein the paint may be provided so as to cover at least a part of an edge of the de-icer component that is furthest away from said apex and said anti-erosion strip.

In any of the examples described herein the paint may be provided so as to cover the connection between the edge of the de-icer component that is furthest away from said anti-erosion strip and the end of the tapered section of the blade leading edge.

In any of the examples described herein, the method may further comprise providing an anti-erosion paint on said blade so that said paint covers at least a part of the external surface of the body of the blade.

In any of the examples described herein, the step of providing said paint may comprise providing said paint so as to cover at least a part of an edge of the de-icer component that is furthest away from said apex and said anti-erosion strip.

In any of the examples described herein, the step of providing said paint may comprise providing said paint so as to cover the connection between the edge of the de-icer component that is furthest away from said anti-erosion strip and the end of the tapered section of the blade leading edge.

In any of the examples described herein the blade may be the blade of a propeller.

### DESCRIPTION OF THE FIGURES

Certain embodiments of the present disclosure will now be described in greater detail by way of example only and with reference to the accompanying drawing in which:

FIG. 1a shows an exploded view of an example of a blade having a new type of de-icing system.

FIG. 1b shows the system of FIG. 1a when assembled.

FIG. 2a shows an exploded view of an example of another new type of de-icing system as described herein.

FIG. 2b shows the system of FIG. 2a when assembled.

### DETAILED DESCRIPTION

The de-icing systems described herein comprises a blade such as a blade for use in a helicopter, wind turbine, aircraft etc. that would require de-icing during use. The examples herein are described with reference to a propeller blade.

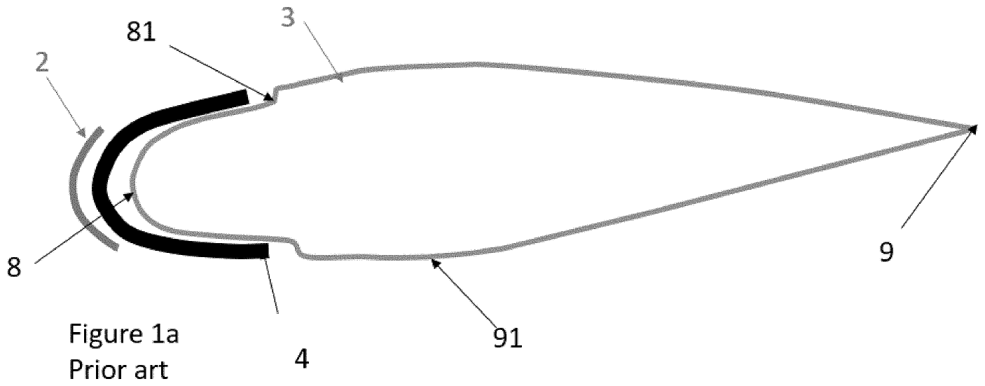

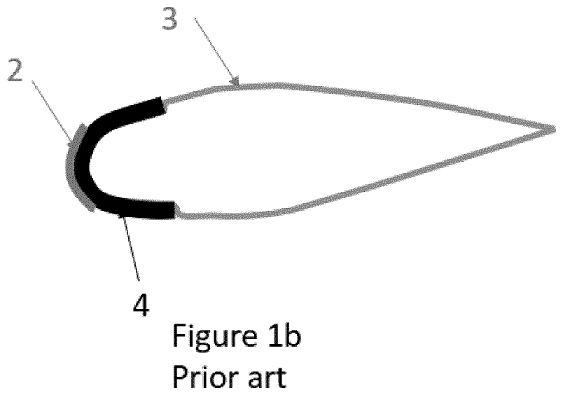

A new type of blade de-icing system is described herein and shown in FIG. 1. The de-icing system comprises the blade 10 that is to be de-iced. The blade has a main body 3 which extends from a leading edge 8 to a trailing edge 9. In use, the trailing edge would be attached to the rotor of a helicopter (not shown). The body 3 may have a section 91 which has a larger thickness than a section at the leading edge which is recessed 81, as shown in FIG. 1a. in some examples the recess is formed via tapering, and in other examples the recess is formed via providing a step in the thickness of the body 3 of the blade 10. A de-icer component 4 is positioned in the recess 81 at the leading edge 8 and an anti-erosion strip 2 may be provided on said de-icing component 4.

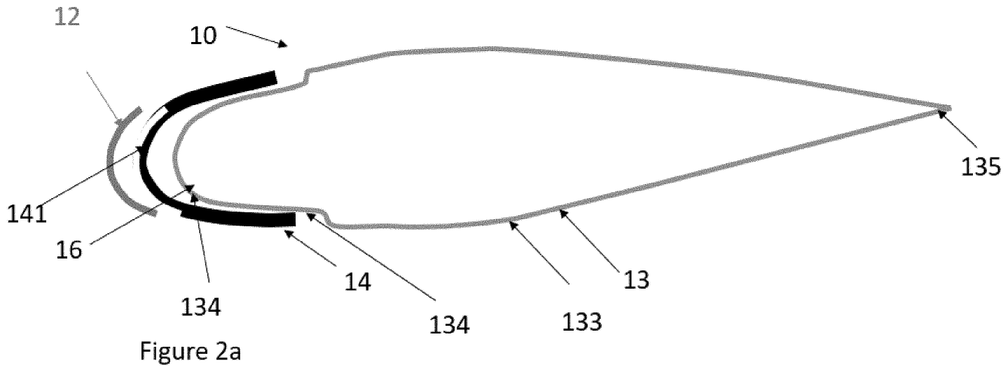

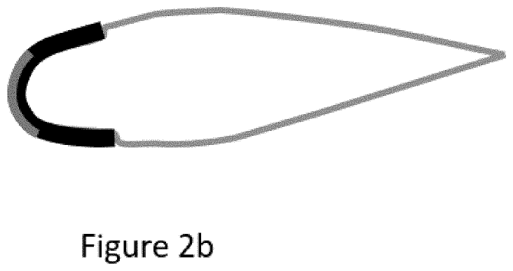

A variant of the examples shown in FIGS. 1a and 1b is shown in FIGS. 2a and 2b. In this example the blade has a main body 13 extending between a trailing edge 135 and a leading edge 11. In use, the blade would be attached to the rotor of a helicopter, or body of the aircraft or wind turbine by a blade root which is usually between the leading edge 11 and the trailing edge 135. The blade may be attached by known techniques. The body 13 of the blade has a main section 133 which in the example shown in FIG. 1 has a first thickness, which extends to a second section 134, which has a second thickness, the second thickness being less than the first thickness as shown in FIG. 2a to form a recess in the main body 13 of the blade, as in the examples shown in FIGS. 1a and 1b. Again; this recess may be formed gradually by tapering, or may alternatively formed by a step in the reduction of thickness. This second, recessed, section 134 extends in the direction of and to the apex 16 of the blade at its leading edge 11.

A de-icer component 14 is provided and may be sized and shaped so that it fits snugly within this recessed section 134 of the main body 13 having the reduced thickness. The de-icer component 14 may be sized and shaped so that, when provided in the recessed section 134, the outer surface of the de-icer component 14 is flush with the outer surface of the first section 133 of the blade so that the surfaces are flush with each other and there is no step between their outer surfaces.

The de-icer component 14 covers at least part of the blade leading edge 11 as shown in FIGS. 2a and 2b. The de-icer component 14 may also extend to cover both the upper and lower surfaces of the blade when in use.

In some examples, the de-icer component 14 may comprise a strip or strips of a heating element embedded in a resin or other matrix that provides anti-erosion protection and also insulates the heating element. In some examples the heating element may comprise a strip of metallic foil that is resistive and generates heat when connected to an electric power supply by the Joule Effect. Other heating elements and matrices could also be envisaged.

An anti-erosion strip 12 is also provided so as to be positioned on or at the apex 16 of the leading edge, and on top of the de-icing component 14 as shown in FIGS. 2a and 2b. In the example shown in FIGS. 2a and 2b the de-icer component 14 may be shaped so that it has an area of reduced thickness at the apex 16, to form a recess 141 in the de-icing component for receiving the anti-erosion strip 12.

The recess 141 of the de-icing component 14 may be sized and shaped and the anti-erosion strip 12 may also be sized and shaped so that the anti-erosion strip 12 fits snugly in the recess 141 so that the outer surface of the anti-erosion strip 12 is flush with the outer surface of the de-icing component 14 so that there is no step in the levels of the outer surfaces when the anti-erosion strip 12 is in position.

In some examples, the anti-erosion strip 12 is a replaceable strip. In some examples, the anti-erosion strip 12 may comprise a polyurethane film. This strip 12 is adhesive and in some examples, the strip may be self-adhesive. In other examples the strip may require adhesive to be added. Such adhesive strips can be easily debonded and replaced by a new one, if necessary. The company 3M are suppliers of such anti-erosion strips. In other examples, the strip may be a thermoplastic film with adhesive added thereto. Any other material which provides good resistance to erosion may also/alternatively be used.

In some examples, the main body of the blade may also have a layer of paint (not shown) that is provided on the external surface of the body 13 of the blade 10. The paint may comprise an anti-erosion paint. In some examples, this may be sprayed onto the body of the blade after the blade has been finished or equipped. This anti-erosion paint may provide erosion protection to the remainder of the propeller blade. In some examples, the paint may be applied to the blade so that it covers at least a part or edge of the de-icer component 14 so as to provide a smooth transition between the junction comprising the edge of the de-icer component 14 that is provided in the recess of the blade and the outer surface of the blade that is adjacent to that recess.

A method of manufacturing this blade 10 having a de-icing system may comprise providing this blade 10 via known techniques so that the blade 10 has the features described above, i.e. a main body 13 that extends to a tapered leading edge 11 apex 16. The method may further comprise, providing a de-icing component 14 as described above, wherein the deicing component 14 has a recessed section 141 and bonding the de-icing component 14 to the blade 10 so that the recessed section 141 of the de-icing component is positioned at the apex 16 of the leading edge 11 of the blade. In the examples wherein the de-icing component 14 is provided so as it is positioned in a recess in the blade, the method may also comprise first forming this recess in the blade, either by tapering the thickness or providing a stepped change in the thickness of the blade.

The method may further comprise providing the anti-erosion strip 12 so that it is positioned so as to fit snugly within the recessed section 141 of the de-icing component 14 so that the outer surface of the anti-erosion strip 12 is flush with the outer surface of the de-icing component 14 as shown in FIG. 2b.

The anti-erosion strip may be adhesive and the step of providing this strip may comprise adhering the strip 12 to the de-icing component 14 and more specifically adhering the strip 12 to the recessed section 141 of the de-icing component 14 so that it is positioned at the apex of the blade 10 in use and so that there is no step between the anti-erosion strip 12 and the de-icer component 14. In some examples the method may also comprise providing paint on the external surface of the body 13 of the blade 10 as described above.

In this method, the de-icer component 14 is therefore formed so that it is bonded to the tapered leading edge of the blade 10 and the anti-erosion adhesive strip 12 is in turn also bonded to the de-icer component 14. The anti-erosion strip 12 may be a polyurethane or elastomer strip and may be self-adhesive.

The systems and methods described herein provide advantages over known de-icing systems and methods as the blades also have improved aerodynamic properties.

In addition to this, since the anti-erosion device is integrated with the de-icer component 14 via an adhesive bond, the combination of the anti-erosion strip 12 and the de-icer component 14 form a smooth outer surface/shape on the outer surface of the blade after the strip 12 has been bonded to the de-icer. This improves the aerodynamic properties of the blade/propeller in contrast to a situation wherein a step is present between the anti-erosion strip 12 and the de-icer component 14. If a step was present between these two components, aerodynamic turbulences would be generated, which, in the case of a propeller would reduce its efficiency.

1. A blade de-icing system to deice a blade, wherein the said blade has a body extending between a leading edge and a trailing edge, said leading edge ending at an apex, the system comprising:
a de-icer component having a recess formed therein and being positioned on said leading edge of said blade so that said de-icer component covers and extends away from said apex and so that said recess is positioned at said apex of said leading edge; and
an anti-erosion strip provided in said recess of said de-icer component;
wherein said anti-erosion strip and said recess are sized and shaped such that said anti-erosion strip fits within said recess so that outer surface of said anti-erosion strip is flush with the outer surface of said de-icer component.

2. The system of claim 1, wherein said anti-erosive strip is adhesive and is bonded via said adhesive to said recess.

3. The system of claim 1, wherein said leading edge is tapered.

4. The system of claim 1, wherein at said leading edge, said body of said blade has a recessed section.

5. The system of claim 4, wherein said de-icing component is shaped and sized so as to fit onto said recessed section of said blade body so that the outer surface of the de-icer component is flush with the outer surface of the body.

6. The system of claim 1, wherein said anti-erosion strip comprises a replaceable strip.

7. The system of claim 1, wherein said de-icer component comprises a heating element provided in a matrix.

8. The system of claim 7, wherein said matrix is epoxy resin.

9. The system of claim 1, wherein an anti-erosion paint is provided so as to cover at least a part of the external surface of the body of the blade.

10. The system of claim 9, wherein said paint is provided so as to cover a junction between the de-icer component and the main body of the blade.

11. The system of claim 9, wherein said paint is provided so as to cover a junction between the de-icer component and anti-erosion strip.

12. The system of claim 8, wherein said paint is provided so as to cover a junction between the de-icer component and anti-erosion strip.

13. A method of manufacturing a blade de-icing system that includes a de-icer component comprising:
providing a blade having a body extending between a leading edge and a trailing edge, said leading edge ending at an apex;
providing a recess in said de-icer component and positioning said de-icer component on said leading edge of said blade so that said de-icer component covers and extends away from said apex and so that said recess is positioned at said apex of said leading edge; and
providing an anti-erosion strip in said recess of said de-icer component;
wherein said anti-erosion strip and said recess are sized and shaped such that said anti-erosion strip fits within said recess so that outer surface of said anti-erosion strip is flush with the outer surface of said de-icer component.

14. The method of claim 13, further comprising providing an anti-erosion paint on said blade so that said paint covers at least a part of the external surface of the body of the blade.

15. The method of claim 14, wherein said step of providing said anti-erosion paint comprises providing said paint so as to cover the junction between de-icer component and said blade body.
